(19) United States
(12) Patent Application Publication
(10) Pub. No.: US 2022/0393922 A1
(43) Pub. Date: Dec. 8, 2022

(54) SIGNAL TRANSMISSION METHOD, TERMINAL DEVICE AND NETWORK DEVICE

(71) Applicant: ZEKU, INC., Palo Alto, CA (US)

(72) Inventors: Jifeng GENG, San Diego, CA (US); Hong Kui YANG, San Diego, CA (US)

(21) Appl. No.: 17/890,193

(22) Filed: Aug. 17, 2022

Related U.S. Application Data
(63) Continuation of application No. PCT/IB2020/056673, filed on Jul. 16, 2020.
(60) Provisional application No. 62/978,011, filed on Feb. 18, 2020.

(51) Int. Cl. H04L 27/26

(52) U.S. Cl. CPC H04L 27/2607

(57) ABSTRACT

Embodiments of apparatus and method for weighted overlap-and-add (WOLA) implementation on streamed symbols are disclosed. In an example, a radio frequency (RF) chip includes a RF front-end and a digital front-end operatively coupled to the RF front-end. The digital front-end includes a set of registers storing a length of a cyclic suffix. The digital front-end also includes a WOLA module configured to copy a portion of a first symbol identified based on the length of the cyclic suffix, and append the copied portion to an end of the first symbol with a ramping-down window to form a weighed cyclic suffix of the first symbol.

### CROSS-REFERENCE TO RELATED APPLICATIONS

This is a continuation of International Application No. PCT/IB2020/056673, filed on Jul. 16, 2020, which claims the benefit of priority to U.S. Provisional Application No. 62/978,011 filed on Feb. 18, 2020, entitled “WOLA IMPLEMENTATION ON STREAMED OFDM SYMBOL,” both of which are hereby incorporated by reference in their entireties.

### BACKGROUND

Embodiments of the present disclosure relate to apparatus and method for wireless communication.

Wireless communication systems are widely deployed to provide various telecommunication services such as telephony, video, data, messaging, and broadcasts. Orthogonal frequency division multiplexing (OFDM) is one of the most widely used and adopted digital multi-carrier modulation methods and has been used extensively for cellular communications, such as 4th-generation (4G) Long Term Evolution (LTE) and 5th-generation (5G) New Radio (NR). One version of OFDM, for example, used in 4G LTE, is cyclic prefix OFDM (CF-OFDM), which has a waveform format that is designed to overcome the inter-symbol interference (ISI) resulting from delays and reflections.

### SUMMARY

Embodiments of apparatus and method for weighed overlap-and-add (WOLA) implementation on streamed symbols are disclosed herein.

In one example, a radio frequency (RF) chip includes a RF front-end and a digital front-end operatively coupled to the RF front-end. The digital front-end includes a set of registers storing a length of a cyclic suffix. The digital front-end also includes a WOLA module configured to copy a portion of a first symbol identified based on the length of the cyclic suffix, and append the copied portion to an end of the first symbol with a ramping-down window to form a weighed cyclic suffix of the first symbol.

In another example, an apparatus for wireless communication includes a baseband chip and a RF chip including a digital front-end. The baseband chip is configured to generate a stream of OFDM symbols. The digital front-end includes a gain control module configured to adjust gains of the stream of OFDM symbols received from the baseband chip, and a WOLA module configured to apply WOLA to the stream of OFDM symbols with adjusted gains in a streamlined manner

In still another example, a method implemented by a RF chip for wireless communication is disclosed. A length of a cyclic suffix is obtained. A portion of a first symbol identified based on the length of the cyclic suffix is copied. The copied portion is appended to an end of the first symbol with a ramping-down window to form a weighed cyclic suffix of the first symbol.

In yet another example, a method for wireless communication is disclosed. A stream of OFDM symbols are generated by a baseband chip. Gains of the stream of OFDM symbols received from the baseband chip are adjusted by a RF chip. WOLA is applied by the RF chip to the stream of OFDM symbols with adjusted gains in a streamlined manner

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates an exemplary wireless network, according to some embodiments of the present disclosure.

FIG. 2 illustrates a block diagram of an apparatus including a baseband chip implementing WOLA on OFDM symbols and a RF chip.

FIG. 3 illustrates a block diagram of an exemplary apparatus including a baseband chip and a RF chip implementing WOLA on OFDM symbols, according to some embodiments of the present disclosure.

FIG. 4 illustrates exemplary CP-OFDM symbols and WOLA-OFDM symbols, according to some embodiments of the present disclosure.

FIG. 5 illustrates a detailed block diagram of an exemplary RF chip of the apparatus shown in FIG. 3, according to some embodiments of the present disclosure.

FIG. 6 illustrates an exemplary WOLA implementation on streamed CP-OFDM symbols, according to some embodiments of the present disclosure.

FIG. 7 illustrates an exemplary frame structure and symbol structure, according to some embodiments of the present disclosure.

FIG. 8 illustrates a flow chart of an exemplary method for WOLA implementation on streamed symbols, according to some embodiments of the present disclosure.

FIG. 9 illustrates a flow chart of another exemplary method for WOLA implementation on streamed symbols, according to some embodiments of the present disclosure.

FIG. 10 illustrates a flow chart of still another exemplary method for WOLA implementation on streamed symbols, according to some embodiments of the present disclosure.

FIG. 11 illustrates a block diagram of an exemplary node, according to some embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications. It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio access technology (RAT), such as Universal Terrestrial Radio Access (UTRA), evolved UTRA (E-UTRA), CDMA 2000, etc. A TDMA network may implement a RAT, such as GSM. An OFDMA network may implement a RAT, such as LTE or NR. The techniques described herein may be used for the wireless networks and RATs mentioned above, as well as other wireless networks and RATs.

One of the drawbacks of conventional OFDM waveforms used in the 4G and 5G wireless networks, such as CP-OFDM, is the large out-of-band (OOB) emissions, despite its ability to inhibit ISI between successive OFDM symbols. These emissions are undesirable and may cause harmful interference to adjacent channels. WOLA is a technique in digital signal processing to effectively reduce the OOB emissions by smoothing the edges between two adjacent OFDM symbols. WOLA-OFDM is based on CP-OFDM where a portion of the OFDM symbol is appended at the end overlapping with the beginning of the next OFDM symbol. In addition, time-domain windowing using a pulse with soft edges can be applied to the appended portion, compared with a rectangular pulse in conventional OFDM. This leads to superior spectral containment and allows a smooth transition from one symbol to the next, which leads to better OOB attenuation compared with CP-OFDM.

Some solutions implement WOLA on the OFDM symbols using a baseband chip. However, as WOLA is effective after digital gain adjustment is applied in the baseband chip, the WOLA-OFDM symbols (also known as CP-OFDM-WOLA symbols) are sent to a RF chip at various power levels, which requires an increased dynamic range of data going through the digital interface between the baseband chip and the RF chip. The larger throughput challenges the digital interface design and increases the power consumption at the digital interface. Some other solutions tried to implement WOLA on the OFDM symbols using a RF chip in which a sample buffer, which is large enough to store the entire OFDM symbol, exists for applying WOLA on each OFDM symbol. The large buffer, which is uncommon for a RF chip, can significantly increase the cost of the RF chip and cause delay and thus, is undesirable. Moreover, storing the entire OFDM symbol in the buffer disrupts the OFDM symbols streaming through the RF chip. That is, WOLA on OFDM symbols may not be applied using a RF chip in a streamlined manner by the known solutions, which further impacts the performance of the RF chip.

Various embodiments in accordance with the present disclosure provide an improved solution for implementing WOLA on streamed symbols, such as OFDM symbols. By introducing symbol boundary signals, the exact samples forming a cyclic suffix can be identified from the symbol based on the symbol boundary signal and preset lengths of the cyclic suffix and cyclic prefix, and then can be extracted from the symbol without disrupting the stream of symbols, i.e., applying WOLA on the symbols in a streamlined manner In some embodiments, a RF chip, instead of a baseband chip, is use for adjusting digital gains first and then implementing WOLA on the streamed symbols, thereby reducing the dynamic range of data, data throughput, and power consumption at the digital interface between the baseband chip and RF chip. Moreover, as only a small portion of each symbol forming the cyclic suffix needs to be extracted, the buffer size on the RF chip can be significantly reduced (e.g., from 2-4 Kbytes to less than 100 bytes), which reduces the cost of the RF chip and the signal delay compared with the known solutions described above.

FIG. 1 illustrates an exemplary wireless network 100, in which certain aspects of the present disclosure may be implemented, according to some embodiments of the present disclosure. As shown in FIG. 1, wireless network 100 may include a network of nodes, such as a user equipment (UE) 102, an access node 104, and a core network element 106. User equipment 102 may be any terminal device, such as a mobile phone, a desktop computer, a laptop computer, a tablet, a vehicle computer, a gaming console, a printer, a positioning device, a wearable electronic device, a smart sensor, or any other device capable of receiving, processing, and transmitting information, such as any member of a vehicle to everything (V2X) network, a cluster network, a smart grid node, or an Internet-of-Things (IoT) node. It is understood that user equipment 102 is illustrated as a mobile phone simply by way of illustration and not by way of limitation.

Access node 104 may be a device that communicates with user equipment 102, such as a wireless access point, a base station (BS), a Node B, an enhanced Node B (eNodeB or eNB), a next-generation NodeB (gNodeB or gNB), a cluster master node, or the like. Access node 104 may have a wired connection to user equipment 102, a wireless connection to user equipment 102, or any combination thereof. Access node 104 may be connected to user equipment 102 by multiple connections, and user equipment 102 may be connected to other access nodes in addition to access node 104. Access node 104 may also be connected to other user equipments. It is understood that access node 104 is illustrated by a radio tower by way of illustration and not by way of limitation.

Core network element 106 may serve access node 104 and user equipment 102 to provide core network services. Examples of core network element 106 may include a home subscriber server (HSS), a mobility management entity (MME), a serving gateway (SGW), or a packet data network gateway (PGW). These are examples of core network elements of an evolved packet core (EPC) system, which is a core network for the LTE system. Other core network elements may be used in LTE and in other communication systems. In some embodiments, core network element 106 includes an access and mobility management function (AMF) device, a session management function (SMF) device, or a user plane function (UPF) device, of a core network for the NR system. It is understood that core network element 106 is shown as a set of rack-mounted servers by way of illustration and not by way of limitation.

Core network element 106 may connect with a large network, such as the Internet 108, or another Internet Protocol (IP) network, to communicate packet data over any distance. In this way, data from user equipment 102 may be communicated to other user equipments connected to other access points, including, for example, a computer 110 connected to Internet 108, for example, using a wired connection or a wireless connection, or to a tablet 112 wirelessly connected to Internet 108 via a router 114. Thus, computer 110 and tablet 112 provide additional examples of possible user equipments, and router 114 provides an example of another possible access node.

A generic example of a rack-mounted server is provided as an illustration of core network element 106. However, there may be multiple elements in the core network including database servers, such as a database 116, and security and authentication servers, such as an authentication server 118. Database 116 may, for example, manage data related to user subscription to network services. A home location register (HLR) is an example of a standardized database of subscriber information for a cellular network. Likewise, authentication server 118 may handle authentication of users, sessions, and so on. In the NR system, an authentication server function (AUSF) device may be the specific entity to perform user equipment authentication. In some embodiments, a single server rack may handle multiple such functions, such that the connections between core network element 106, authentication server 118, and database 116, may be local connections within a single rack.

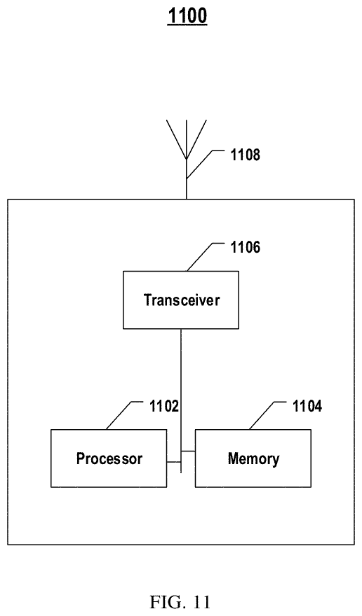

Each element in FIG. 1 may be considered a node of wireless network 100. More detail regarding the possible implementation of a node is provided by way of example in the description of a node 1100 in FIG. 11. Node 1100 may be configured as user equipment 102, access node 104, or core network element 106 in FIG. 1. Similarly, node 1100 may also be configured as computer 110, router 114, tablet 112, database 116, or authentication server 118 in FIG. 1. As shown in FIG. 11, node 1100 may include a processor 1102, a memory 1104, and a transceiver 1106. These components are shown as connected to one another by a bus, but other connection types are also permitted. When node 1100 is user equipment 102, additional components may also be included, such as a user interface (UI), sensors, and the like. Similarly, node 1100 may be implemented as a blade in a server system when node 1100 is configured as core network element 106. Other implementations are also possible.

Transceiver 1106 may include any suitable device for sending and/or receiving data. Node 1100 may include one or more transceivers, although only one transceiver 1106 is shown for simplicity of illustration. An antenna 1108 is shown as a possible communication mechanism for node 1100. Multiple antennas and/or arrays of antennas may be utilized. Additionally, examples of node 1100 may communicate using wired techniques rather than (or in addition to) wireless techniques. For example, access node 104 may communicate wirelessly to user equipment 102 and may communicate by a wired connection (for example, by optical or coaxial cable) to core network element 106. Other communication hardware, such as a network interface card (NIC), may be included as well.

As shown in FIG. 11, node 1100 may include processor 1102. Although only one processor is shown, it is understood that multiple processors can be included. Processor 1102 may include microprocessors, microcontroller units (MCUs), digital signal processors (DSPs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 1102 may be a hardware device having one or more processing cores. Processor 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

As shown in FIG. 11, node 1100 may also include memory 1104. Although only one memory is shown, it is understood that multiple memories can be included. Memory 1104 can broadly include both memory and storage. For example, memory 1104 may include random-access memory (RAM), read-only memory (ROM), static RAM (SRAM), dynamic RAM (DRAM), ferro-electric RAM (FRAM), electrically erasable programmable ROM (EEPROM), CD-ROM or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 1102. Broadly, memory 1104 may be embodied by any computer-readable medium, such as a non-transitory computer-readable medium.

Processor 1102, memory 1104, and transceiver 1106 may be implemented in various forms in node 1100 for performing wireless communication functions. In some embodiments, processor 1102, memory 1104, and transceiver 1106 of node 1100 are implemented (e.g., integrated) on one or more system-on-chips (SoCs). In one example, processor 1102 and memory 1104 may be integrated on an application processor (AP) SoC (sometimes known as a “host,” referred to herein as a “host chip”) that handles application processing in an operating system environment, including generating raw data to be transmitted. In another example, processor 1102 and memory 1104 may be integrated on a baseband processor (BP) SoC (sometimes known as a “modem,” referred to herein as a “baseband chip”) that converts the raw data, e.g., from the host chip, to signals that can be used to modulate the carrier frequency for transmission, and vice versa, which can run a real-time operating system (RTOS). In still another example, processor 1102 and transceiver 1106 (and memory 1104 in some cases) may be integrated on a RF SoC (sometimes known as a “transceiver,” referred to herein as a “RF chip”) that transmits and receives RF signals with antenna 1108. It is understood that in some examples, some or all of the host chip, baseband chip, and RF chip may be integrated as a single SoC. For example, a baseband chip and an RF chip may be integrated into a single SoC that manages all the radio functions for cellular communication.

Referring back to FIG. 1, in some embodiments, any suitable node of wireless network 100 (e.g., user equipment 102 or access node 104) in transmitting signals to another node, for example, from user equipment 102 to access node 104 via an uplink (UL), may implement WOLA on streamed symbols (e.g., a stream of OFDM symbols) in a streamlined manner using a RF chip, instead of a baseband chip, as described below in detail. As a result, compared with known solutions, the dynamic data range, data throughput, and power consumption at the digital interface between the baseband chip and the RF chip can be reduced without introducing additional cost and delay on the RF chip.

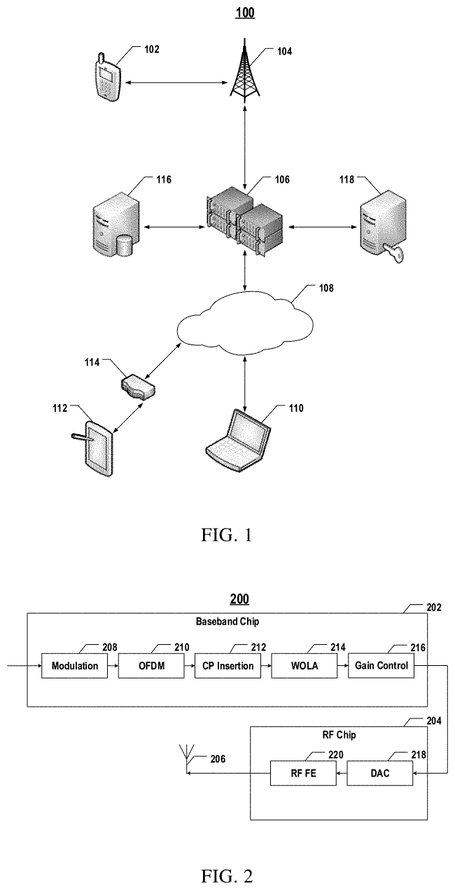

As one example of known solutions, FIG. 2 illustrates a block diagram of an apparatus 200 including a baseband chip 202 implementing WOLA on OFDM symbols and a RF chip 204. Apparatus 200 includes baseband chip 202 configured to generate and transmit WOLA-OFDM symbols to RF chip 204. RF chip 204, operatively coupled to baseband chip 202 and an antenna 206, is configured to transmit WOLA-OFDM symbols in RF signals through antenna 206. Baseband chip 202 includes a modulation module 208, an OFDM module 210, a cyclic prefix (CP) insertion module 212, a WOLA module 214, and a gain control module 216 in the uplink. RF chip 204 includes a digital-to-analog converter (DAC) 218 and a RF front-end (FE) 220 in the uplink. It is understood that additional modules in the downlink of baseband chip 202 and RF chip 204 are omitted for ease of description.

CP-OFDM symbols are generated after being processed by CP insertion module 212 and are fed into WOLA module 214 for applying WOLA to each CP-OFDM symbol in baseband chip 202 to generate WOLA-OFDM symbols. When performing CP insertion and WOLA, the entire CP-OFDM symbol is stored in a buffer (not shown) of baseband chip 202, and the samples in the OFDM symbol forming the cyclic prefix or cyclic suffix are copied based on memory addressing in the buffer. The gain (e.g., power or amplitude) of each WOLA-OFDM symbol is then adjusted by gain control module 216 of baseband chip 202. As a result, WOLA-OFDM symbols with adjusted gains are transmitted from baseband chip 202 to RF chip 204. The digital interface (not shown) in baseband chip 202 transmitting the WOLA-OFDM symbols and the digital interface (not shown) in RF chip 204 receiving the WOLA-OFDM symbols need to accommodate WOLA-OFDM symbols at various gain levels and the resulting large data throughput and power consumption. Also, the continuity between adjacent WOLA-OFDM symbols in the time domain may be broken up by the subsequent gain adjustment applied to WOLA-OFDM symbols at various power levels.

In contrast, FIG. 3 illustrates a block diagram of an exemplary apparatus 300 including a baseband chip 302 and a RF chip 304 implementing WOLA on OFDM symbols, according to some embodiments of the present disclosure. As described below in detail, by transmitting OFDM or CP-OFDM symbols without WOLA and adjusted gains to RF chip 304 and implementing WOLA on the OFDM or CP-OFDM symbols (and gain control) using RF chip 304, the design of the digital interfaces in baseband chip 302 and RF chip 304 can be simplified, and the power consumption can be reduced. Moreover, as WOLA is applied after gain adjustment, the continuity between adjacent WOLA-OFDM symbols in the time domain and the smooth transition at the boundary edges can be maintained. Apparatus 300 may be an example of any suitable node of wireless network 100, such as user equipment 102. As shown in FIG. 3, apparatus 300 may include baseband chip 302, RF chip 304, and an antenna 306. In some embodiments, baseband chip 302 is implemented by processor 1102 and memory 1104, and RF chip 304 is implemented by processor 1102, memory 1104, and transceiver 1106, as described above with respect to FIG. 11. It is understood that besides the various modules of baseband chip 302 and RF chip 304 in the uplink shown in FIG. 3, any other suitable modules, such as modules in the downlink, may be included in baseband chip 302 and RF chip 304 as well.

In some embodiments, baseband chip 302 includes a modulation module 308, an OFDM module 310, and a cyclic prefix (CP) insertion module 312 in the uplink. Modulation module 308 may be configured to modulate the raw data from a host chip or raw data after coding (e.g., source coding and/or channel coding) using any suitable modulation techniques, such as multi-phase pre-shared key (MPSK) modulation or quadrature amplitude modulation (QAM). OFDM module 310 may be configured to generate a stream of OFDM symbols on multiple subcarriers based on the modulated data. In some embodiments, OFDM module 310 includes a serial-to-parallel converter, an inverse fast Fourier transform (IFFT) unit, and a parallel-to-serial converter. Cyclic prefix insertion module 312 may be configured to insert a cyclic prefix (e.g., the last portion of the OFDM symbol) at the beginning of each OFDM symbol with guard interval exceeding delay spread of the multipath channel to mitigate the effect of ISI. A stream of CP-OFDM symbols thus can be generated by cyclic prefix insertion module 312 and transmitted through a digital interface (not shown) without applying WOLA and digital gain adjustment, i.e., with more uniform symbol levels, smaller dynamic data range and throughout, and reduced power consumption at the digital interface of baseband chip 302, compared with the example shown in FIG. 2.

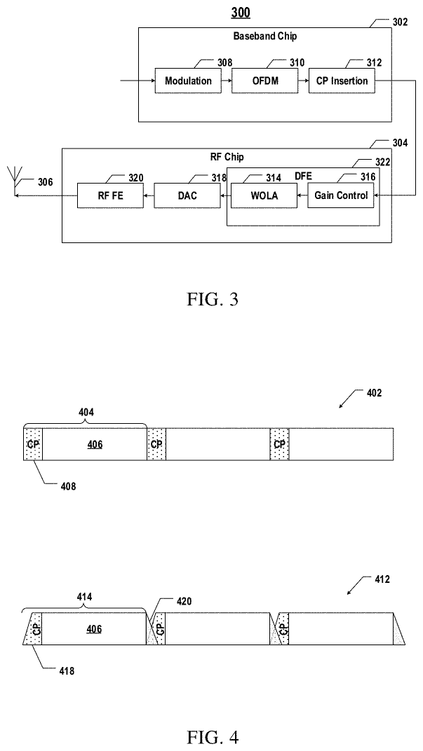

For example, FIG. 4 illustrates a stream 402 of CP-OFDM symbols 404 in the time domain. Each CP-OFDM symbol 404 may include a payload 406 carrying data and a cyclic prefix 408 at the beginning of CP-OFDM symbol 404, which can preserve the orthogonality of the subcarriers and serve as a guard interval preventing ISI between successive CP-OFDM symbols 404. When the signal is demodulated, the N-point fast Fourier transform (FFT) is taken at payload 406 after cyclic prefix 408. In some embodiments, the last portion of payload 406 (e.g., some samples at the end of payload 406) of CP-OFDM symbol 404 is inserted at the beginning of payload 406 of CP-OFDM symbol 404 as cyclic prefix 408.

Referring back to FIG. 3, RF chip 304 may include a digital front-end (FE) 322, a digital-to-analog converter (DAC) 318, and a RF front-end (FE) 320 in the uplink. Digital front-end 322 may be implemented by processor 1102 shown in FIG. 11, such as one or more MCUs and/or DSPs. Digital front-end 322 may include any elements that process digital signals in RF chip 304 before digital-to-analog converter 318 that converts the digital signals into analog signals (e.g., RF signals) for RF front-end 320 to process. In some embodiments, digital front-end 322 includes a gain control module 316 and a WOLA module 314. Gain control module 316 may be configured to receive a stream of CP-OFDM symbols (without WOLA and gain adjustment) from baseband chip 302 through a digital interface (not shown), and perform digital gain adjustment on the stream of CP-OFDM symbols. For example, gain control module 316 may be configured to adjust the gain (power or amplitude) of each CP-OFDM symbol prior to applying WOLA on the CP-OFDM symbols. Additional elements may be included in digital front-end 322 to perform any other front-end functions on digital signals, such as filtering, up-conversion, or sample-rate conversion.

As described below in detail, WOLA module 314 of digital front-end 322 in RF chip 304 may be configured to apply WOLA to the stream of CP-OFDM symbols with adjusted gains in a streamlined manner That is, WOLA module 314 can generate a stream of WOLA-OFDM symbols after digital gain adjustment in real-time without storing an entire symbol in a large buffer in RF chip 304. In some embodiments, WOLA module 314 is configured to copy a portion of each CP-OFDM symbol as a cyclic suffix and append the copied cyclic suffix to the end of the CP-OFDM symbol with a ramping-down window to form a weighed cyclic suffix. Different from some known solutions in which the entire symbol needs to be stored into and then retrieved from a buffer in order to copy the cyclic suffix by memory addressing, which breaks the continuous flow of the streamed symbols, WOLA module 314 may identify the exact location and length of the samples in the CP-OFDM symbol forming the cyclic suffix based on a symbol boundary signal and preset lengths of the cyclic prefix and cyclic suffix. As a result, WOLA module 314 may store only the identified portion in a buffer with a much smaller size fitting the cyclic suffix size (e.g., not greater than 100 bytes vs. 2-4 Kbytes). The CP-OFDM symbols thus may continue streaming through digital front-end 322 in RF chip 304 as WOLA module 314 is applying WOLA on the streamed CP-OFDM symbols, i.e., in a streamlined manner Thus, compared with the known solutions, the delay and cost due to the large-sized buffer can be reduced in RF chip 304 of apparatus 300.

For example, FIG. 4 illustrates a stream 412 of WOLA-OFDM symbols 414 in the time domain. Each WOLA-OFDM symbol 414 may include a weighted cyclic prefix 418 at the beginning of WOLA-OFDM symbol 414, followed by payload 406. A weight cyclic suffix 420 may be appended to the end of WOLA-OFDM symbol 414. Weighted cyclic prefix 418 and weight cyclic suffix 420 may be formed by a windowing process that applies a ramping-up window and ramping-down window (weights), respectively. In some embodiments, the last portion of payload 406 (e.g., some samples at the end of payload 406) of WOLA-OFDM symbol 414 is multiplied with a ramping-up window and inserted at the beginning of payload 406 of CP-OFDM symbol 404 as weighted cyclic prefix 418. In some embodiments, the beginning portion of payload 406 (e.g., some samples at the beginning of payload 406) of WOLA-OFDM symbol 414 is multiplied with a ramping-down window and appended to the end of payload 406 of CP-OFDM symbol 404 as weighted cyclic suffix 420. As weighted cyclic suffix 420 of each WOLA-OFDM symbol 414 may overlap weighted cyclic prefix 418 of the next WOLA-OFDM symbol 414, the summation of weighted cyclic suffix 420 and weighted cyclic prefix 418 of successive WOLA-OFDM symbols 414 can form a smooth transition between the boundaries of successive WOLA-OFDM symbols 414, which helps to reduce the OOB emissions.

Referring back to FIG. 3, digital-to-analog converter 318 may be configured to convert the stream of WOLA-OFDM symbols in digital signals into analog signals (e.g., radio signals). RF front-end 320 (also known as “analog front-end”) may include any elements between antenna 306 and digital-to-analog converter 318, which handles analog signals. RF front-end 320 may include, for example, RF filters, RF amplifiers, local oscillators, and mixers.

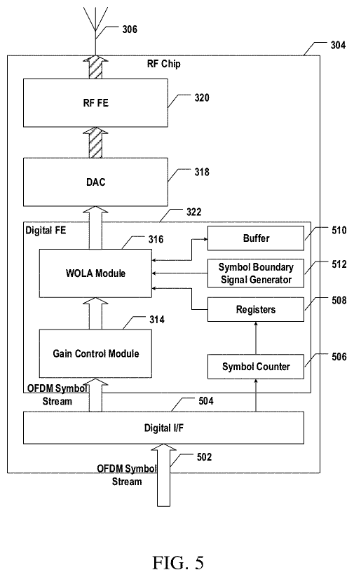

FIG. 5 illustrates a detailed block diagram of exemplary RF chip 304 of apparatus 300 shown in FIG. 3, according to some embodiments of the present disclosure. As described above with respect to FIG. 3, RF chip 304 may include a digital interface (I/F) 504, digital front-end 322 including gain control module 316, and WOLA module 314, digital-to-analog converter 318, and RF front-end 320. As shown in FIG. 5, in some embodiments, digital front-end 322 further includes a symbol counter 506, a set of registers 508, a buffer 510, and a symbol boundary signal generator 512, which facilitate WOLA module 314 to perform the improved WOLA implementation on streamed symbols using RF chip 304 disclosed herein.

In some embodiments, digital interface 504 is configured to receive a stream of OFDM symbols 502 (e.g., CP-OFDM symbols) from a baseband chip, such as baseband chip 302 in FIG. 3. The stream of OFDM symbols generated by the baseband chip may be free of WOLA and adjusted gains, which has a relatively small dynamic data range, data throughput, and less impact on power consumption of digital interface 504. Streamed OFDM symbols 502 may be received by digital interface 504 and transmitted to digital front-end 322 as a continuous data flow. In some embodiments, gain control module 316 is configured to adjust gains of stream of OFDM symbols 502 received from the baseband chip through digital interface 504.

In some embodiments, symbol boundary signal generator 512 is configured to periodically generate symbol boundary signals each indicative of the beginning of a respective cyclic prefix of each OFDM symbol of streamed OFDM symbols 502. For a CP-OFDM symbol including a cyclic prefix at the beginning of the OFDM symbol, symbol boundary signals may be generated by symbol boundary signal generator 512 in the same repetition rate as streamed OFDM symbols 502 (e.g., synchronized with streamed OFDM symbols 502), such that each symbol boundary signal may be aligned with the beginning of a respective CP-OFDM symbol. Each symbol boundary signal may be a pulse generated by any suitable circuits, such as a pulse generator, synchronization circuits, and clock circuits, in symbol boundary signal generator 512.

In some embodiments, registers 508 in digital front-end 322 are configured to store a set of preset lengths of cyclic prefix and cyclic suffix. For example, registers 508 may store the length of the cyclic prefix and the length of the cyclic suffix, respectively. Registers 508 may be implemented by memory 1104 in FIG. 11 and may include, for example, a ROM in case the set of preset lengths of cyclic prefix and cyclic suffix do not change, or a RAM in case one or more of the preset lengths of cyclic prefix and cyclic suffix may be updated. The size of registers 508 is relatively small, for example, just enough for storing the values of the preset lengths of cyclic prefix and cyclic suffix (e.g., not greater than 10 bytes). The preset lengths of cyclic prefix and cyclic suffix may be defined based on any relevant standards, such as from the 3rd Generation Partnership Project (3GPP), or the specification from the manufacturers and/or operators (e.g., cellular service providers) of RF chips 304. It is understood that more than one length may be preset for the cyclic prefix and/or cyclic suffix in some examples. For example, the cyclic prefix may include more than one length, such as a first length of a normal cyclic prefix, and a second length of an extended cyclic prefix (larger than the first length), both of which are stored in registers 508.

In some embodiments, WOLA module 314 in digital front-end 322 is configured to copy a portion of each OFDM symbol in streamed OFDM symbols 502 identified based on the respective symbol boundary signal, the length of the cyclic prefix, and the length of the cyclic suffix. WOLA module 314 may be configured to first identify the beginning of the copied portion of the respective OFDM symbol based on the respective symbol boundary signal and the length of the cyclic prefix, and then determine the length of the copied portion of the respective OFUM symbol based on the length of the cyclic suffix. WOLA module 314 may obtain the preset lengths of cyclic prefix and cyclic suffix of each OFDM symbol from resisters 508 for identifying the portion forming the cyclic suffix in the perspective OFDM symbol.

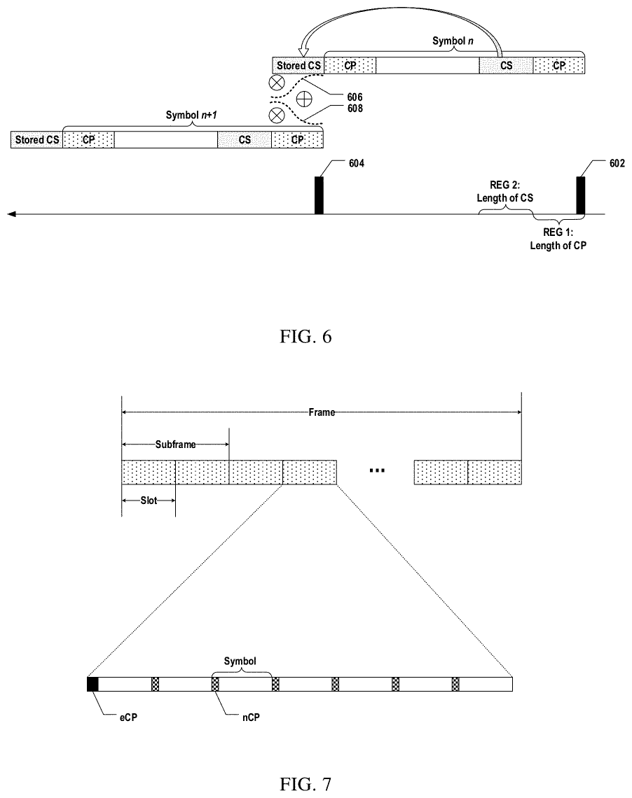

For example, FIG. 6 illustrates an exemplary WOLA implementation on streamed CP-OFDM symbols, according to some embodiments of the present disclosure. As shown in FIG. 6, a portion (CS) of a CP-OFDM symbol n may be identified based on a symbol boundary signal 602 corresponding to symbol n, which indicates (e.g., being aligned with) the beginning of symbol n (e.g., the beginning of the cyclic prefix (CP)), the length of CP stored in a first register (REG 1), and the length of CS stored in a second register (REG 2). For example, as CS may be the first portion of the payload in symbol n, i.e., the portion immediately after CP, the beginning of CS may be identified based on symbol boundary signal 602 and the length of CP in REG 1, i.e., the sample after the length of CP from symbol boundary signal 602. The length of CS may be determined based on the length of CS in REG 2. For example, assuming the lengths of CP and CS are x samples and y samples, CS may be identified as the y samples from the (x+1)th sample to the (x+y+1)th sample in symbol n.

Referring back to FIG. 5, buffer 510 is configured to store the copied portion of the OFDM symbol, according to some embodiments. Buffer 510 may be implemented by memory 1104 of FIG, 11, e.g., SRAM. Different from known solutions that need a large buffer to store the entire OFDM symbol (e.g., having a size of 2-4 Kbytes), by identifying the exact portion forming the cyclic suffix in the OFDM symbol as the OFDM symbol streams through digital front-end 322, buffer 510 can have a much smaller size for storing just the identified portion, but not the entire OFDM symbol. In some embodiments, the size of buffer 510 is not greater than 100 bytes. In some embodiments, to copy the identified portion of the OFDM symbol, WOLA module 314 is configured to store the identified portion into buffer 510 as the OFDM symbol streams through digital front-end 322, and retrieve the stored portion from buffer 510 in response to the end of the OFUM symbol reaching digital front-end 322.

In some embodiments, WOLA module 314 of digital front-end 322 is further configured to append the copied portion to the end of the respective OFDM symbol with a ramping-down window to form a weighed cyclic suffix of the respective OFDM symbol. WOLA module 314 may first perform a windowing process, for example, by multiplying the copied portion with a weight (e.g., a ramping-down window), and then append the weighted copied portion to the end of the OFDM symbol as the weighted cyclic suffix of the OFDM symbol. The weighed cyclic suffix of each OFDM symbol may overlap the cyclic prefix of another OFDM symbol next to the respective OFDM symbol. A windowing process may be performed on the cyclic prefix of each OFDM symbol as well, for example, by multiplying the cyclic prefix with a weight (e.g., a ramping-up window) by, for example, cyclic prefix insertion module 312 in baseband chip 302 or WOLA module 314 in RF chip 304. The weighted cyclic prefix and weighed cyclic suffix of successive OFDM symbols may overlap at the symbol boundary, forming a smooth transition to reduce the OOB emissions.

As shown in FIG. 6, CS of symbol n, identified based on symbol boundary signal 602, the length of CP, and the length of CS, may be stored into a buffer (e.g., buffer 510 in FIG. 5) while symbol n continues to stream. In response to reaching the end of symbol n, CS stored in the buffer (stored CS) may be retrieved from the buffer and appended to the end of symbol n when symbol n streams to its end. Stored CS may be weighed by multiplying a ramping-down window 606. During the course of applying WOLA to form stored CS, symbol n is not stored in a buffer, but keeps streaming through, for example, digital front-end 322 of RF chip 304, i.e., in a streamlined manner As shown in FIG. 6, stored CS of symbol n may overlap CP of symbol n+1 next to symbol n, which is indicated by next symbol boundary signal 604. CP of symbol n+1 may be weighed by multiplying a ramping-up window 608, and the overlapped weighed CP of symbol n+1 and weighed stored CS of symbol n may be added to form a smooth transition between symbol n and symbol n+1. As symbol n+1 continues to flow, the same WOLA process described above with respect to symbol n may be repeated for symbol n+1.

Referring back to FIG. 5, in some embodiments, symbol counter 506 is configured to count the number of OFDM symbols in a slot. It is understood that there may be more than one preset length of the cyclic prefix or cyclic suffix, for example, according to the standards. For example, the length of the cyclic prefix may include a first preset length of a normal cyclic prefix and a second preset length of an extended cyclic prefix. The extended cyclic prefix may appear at one or more OFDM symbols with preset numbers in each slot, for example, according to the standards, and the rest OFDM symbols each have a normal cyclic prefix. Thus, in some embodiments, WOLA module 314 is further configured to apply the length of the normal cyclic prefix or the length of the extended cyclic prefix to identify the beginning of the copied portion of the respective OFDM symbol based on the number of the OFDM symbols in the slot. For example, symbol counter 506 may count the number of OFDM symbols streaming through digital interface 504 and notify registers 508 to provide the corresponding length of the normal cyclic prefix or extend cyclic prefix to WOLA module 314.

For example, FIG. 7 illustrates an exemplary frame structure and symbol structure, according to some embodiments of the present disclosure. As shown in FIG. 7, a radio frame may have a length of 10 milliseconds (ms) and may be divided into 10 equally sized subframes of 1 ms in length. Scheduling may be done on a subframe basis for both the downlink and uplink. Each subframe consists of two equally sized slots of 0.5 ms in length. Each slot in turn consists of a number of OFDM symbols, e.g., 6 or 7 OFDM symbols. Each ODFM symbol, depending on its number in the slot, may include an extended cyclic prefix (eCP) or a normal cyclic prefix (nCP). For example, the first OFDM symbol may include an eCP, while the second to seventh ODFM symbols each may include a nCP. By counting the number of ODFM symbols in each slot, the corresponding length of eCP or nCP may be applied. It is understood that the example in FIG. 7 is for illustrative purposes only and is not limiting. The total number of symbols in each slot, and/or the specific number(s) of symbol(s) having an eCP or nCP may vary in other examples. It is further understood that the eCP and nCP may vary in the slot level as well, meaning that in one slot, each symbol may include the eCP, while in another slot, each symbol may include the nCP. Thus, a slot counter (not shown) may be used to count the number of slots in each subframe or frame to determine the corresponding length of cyclic prefix in the slot.

Referring back to FIG. 5, as described above, WOLA module 316 is configured to apply WOLA to the stream of OFDM symbols 502 with adjusted gains in a streamlined manner, such that each OFDM symbol can sequentially stream through digital front-end 322, digital-to-analog converter 318, and RF front-end 320 without being stored in a large buffer. Digital-to-analog converter 318 is configured to convert the stream of OFDM symbols 502 from digital signals to analog signals (e.g., RF signals) before being processed by RF front-end 320 and transmitted by antenna 306, according to some embodiments.

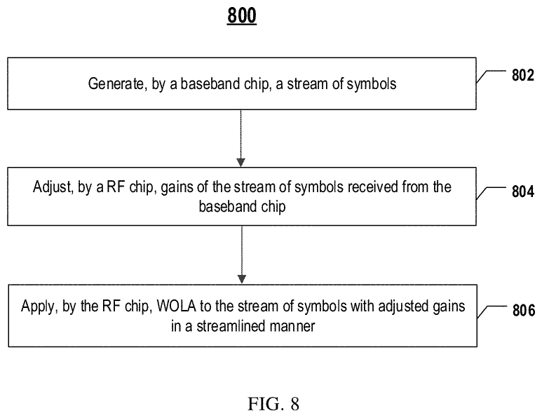

FIG. 8 illustrates a flow chart of an exemplary method 800 for WOLA implementation on streamed symbols, according to some embodiments of the present disclosure. Examples of the apparatus that can perform operations of method 800 include, for example, apparatus 300 depicted in FIG. 3 or any other suitable apparatus disclosed herein. It is understood that the operations shown in method 800 are not exhaustive and that other operations can be performed as well before, after, or between any of the illustrated operations. Further, some of the operations may be performed simultaneously, or in a different order than shown in FIG. 8.

Referring to FIG. 8, method 800 starts at operation 802, in which a stream of symbols are generated by a baseband chip. The stream of symbols generated by the baseband chip may be free of WOLA and adjusted gains. In some embodiments, each symbol is an OFDM symbol. As shown in FIG. 3, baseband chip 302 may generate a stream of OFDM symbols without applying WOLA and digital gain adjustment.

Method 800 proceeds to operation 804, as illustrated in FIG. 8, in which gains of the stream of symbols received from the baseband chip are adjusted by a RF chip. As shown in FIG. 3, digital front-end 322 of RF chip may receive the stream of OFDM symbols from baseband chip 302 and adjust the gains of the stream of OFDM symbols.

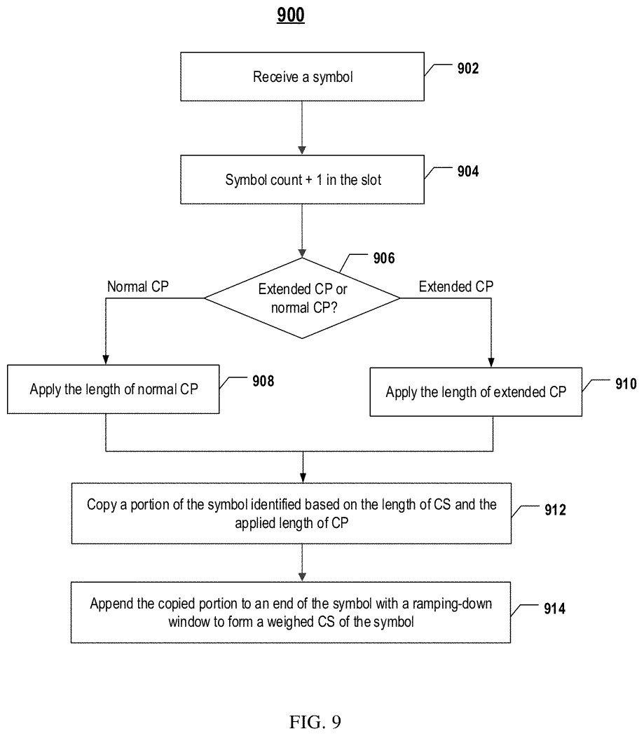

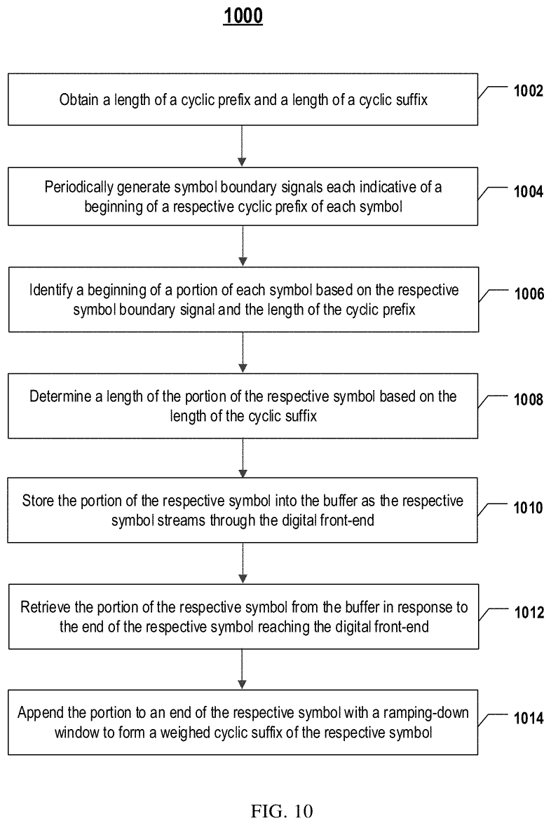

Method 800 proceeds to operation 806, as illustrated in FIG. 8, in which WOLA is applied by the RF chip to the stream of symbols with adjusted gains in a streamlined manner As shown in FIG. 3, digital front-end 322 of RF chip may perform a WOLA process described herein on the stream of OFDM symbols with adjusted gains in a streamlined manner The details of operation 806 are described below with respect to FIGS. 9 and 10.

FIG. 9 illustrates a flow chart of another exemplary method 900 for WOLA implementation on streamed symbols, according to some embodiments of the present disclosure. Examples of the apparatus that can perform operations of method 900 include, for example, RF chip 304 depicted in FIGS. 3 and 5 or any other suitable apparatus disclosed herein. It is understood that the operations shown in method 900 are not exhaustive and that other operations can be performed as well before, after, or between any of the illustrated operations. Further, some of the operations may be performed simultaneously, or in a different order than shown in FIG. 9.

Referring to FIG. 9, method 900 starts at operation 902, in which a symbol, for example, an OFDM symbol, is received. As shown in FIG. 5, digital interface 504 in RF chip 304 may receive an OFDM symbol. Method 900 proceeds to operation 904, as illustrated in FIG. 9, in which the number of symbols in the slot is counted, for example, by increasing one (“+1”). As shown in FIG. 5, symbol counter 506 of digital front-end 322 in RF chip 304 may count the number of the OFDM symbols in the current slot. Method 900 proceeds to operation 906, as illustrated in FIG. 9, in which whether the symbol includes an extended cyclic prefix or a normal cyclic prefix is determined based on the number of symbols in the slot, for example, according to the standards. If the symbol includes a normal cyclic prefix, method 900 proceeds to operation 908, as illustrated in FIG. 9, in which the length of the normal cyclic prefix is applied. If the symbol includes an extended cyclic prefix, method 900 proceeds to operation 910, as illustrated in FIG. 9, in which the length of the extended cyclic prefix is applied. As shown in FIG. 5, WOLA module 314 of digital front-end 322 in RF chip 304 may obtain the preset length of a normal cyclic prefix or the preset length of an extended cyclic prefix stored in registers 508 depending on the number of OFDM symbols in the current slot.

Nevertheless, method 900 proceeds to operation 912, as illustrated in FIG. 9, in which a portion of the symbol identified based on the length of a cyclic suffix and the applied length of the normal cyclic prefix or extended cyclic prefix is copied. In some embodiments, a symbol boundary signal is generated and used for identifying the copied portion of the symbol as well. In some embodiments, the beginning of the copied portion of the symbol is identified based on the symbol boundary signal and the length of the normal cyclic prefix or extended cyclic prefix, and the length of the copied portion of the symbol is determined based on the length of the cyclic suffix. As shown in FIG. 5, symbol boundary signal generator 512 of digital front-end 322 in RF chip 304 may periodically generate symbol boundary signals each indicative of the beginning of a respective cyclic prefix of each OFDM symbol, and WOLA module 314 may obtain the length of the cyclic suffix from registers 508 of digital front-end 322 as well. WOLA module 314 then may identify a portion of the OFDM symbol based on the length of the cyclic suffix and the applied length of the normal cyclic prefix or extended cyclic prefix and copy the identified portion. Method 900 proceeds to operation 914, as illustrated in FIG. 9, in which the copied portion is appended to the end of the symbol with a ramping-down window to form a weighed cyclic suffix of the symbol. As shown in FIG. 5, WOLA module 314 may multiply the copied portion of the OFDM symbol with a ramping-down window to form a weighed cyclic suffix of the OFDM symbol, and then append the weighed cyclic suffix to the end of the OFDM symbol. The details of operations 912 and 914 are described below with respect to FIG. 10.

FIG. 10 illustrates a flow chart of still another exemplary method 1000 for WOLA implementation on streamed symbols, according to some embodiments of the present disclosure. Examples of the apparatus that can perform operations of method 1000 include, for example, RF chip 304 depicted in FIGS. 3 and 5 or any other suitable apparatus disclosed herein. It is understood that the operations shown in method 1000 are not exhaustive and that other operations can be performed as well before, after, or between any of the illustrated operations. Further, some of the operations may be performed simultaneously, or in a different order than shown in FIG. 10.

Referring to FIG. 10, method 1000 starts at operation 1002, in which the length of the cyclic prefix and the length of the cyclic suffix are obtained. In some embodiments, the length of the cyclic prefix includes the length of a normal cyclic prefix and the length of an extended cyclic prefix. As shown in FIG. 5, registers 508 of digital front-end 322 in RF chip 304 may store the preset length of the cyclic prefix and the preset length of the cyclic suffix of an OFDM symbol. Method 1000 proceeds to operation 1004, as illustrated in FIG. 10, in which symbol boundary signals each indicative of the beginning of a respective cyclic prefix of each symbol are periodically generated. As shown in FIG. 5, symbol boundary signal generator 512 of digital front-end 322 in RF chip 304 may periodically generate symbol boundary signals each aligned with the beginning of a respective OFDM symbol.

Method 1000 proceeds to operation 1006, as illustrated in FIG. 10, in which the beginning of a portion of each symbol is identified based on the respective symbol boundary signal and the length of the cyclic prefix. Method 1000 proceeds to operation 1008, as illustrated in FIG. 10, in which the length of the copied portion of the respective symbol is determined based on the length of the cyclic suffix. As shown in FIG. 5, WOLA module 314 of digital front-end 322 in RF chip 304 may identify the beginning of a portion of an OFDM symbol forming the cyclic suffix based on the corresponding symbol boundary signal and the preset length of the cyclic prefix of the OFDM symbol, and then determine the length of the portion based on the preset length of the cyclic suffix.

Method 1000 proceeds to operation 1010, as illustrated in FIG. 10, in which the portion of the respective symbol is stored in the buffer as the respective symbol streams through the digital front-end. In some embodiments, the size of the buffer is not greater than 100 bytes. Method 1000 proceeds to operation 1012, as illustrated in FIG. 10, in which the portion of the respective symbol is retrieved from the buffer in response to the end of the respective symbol reaching the digital front-end. As shown in FIG. 5, WOLA module 314 may store the identified portion of the OFDM symbol into buffer 510 while the OFDM symbol continues flowing through digital front-end 322, and then retrieve the stored portion of the OFDM symbol from buffer 510 when the end of the OFDM symbol reaches digital front-end 322.

Method 1000 proceeds to operation 1014, as illustrated in FIG. 10, in which the copied portion is appended to the end of the respective symbol with a ramping-down window to form a weighted cyclic suffix of the respective symbol. In some embodiments, the weighed cyclic suffix of the respective symbol overlaps the cyclic prefix of the next symbol. As shown in FIG. 5, WOLA module 314 may multiply the retrieved portion of the OFDM symbol with a ramping-down window, and then append the weighed cyclic suffix to the end of the OFDM symbol.

In various aspects of the present disclosure, the functions described herein may be implemented in hardware, software, firmware, or any combination thereof. If implemented in software, the functions may be stored on or encoded as instructions or code on a non-transitory computer-readable medium. Computer-readable media includes computer storage media. Storage media may be any available media that can be accessed by a computing device, such as node 1100 in FIG. 11. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, DVD, and floppy disk where disks usually reproduce data magnetically, while discs reproduce data optically with lasers. Combinations of the above should also be included within the scope of computer-readable media.

According to one aspect of the present disclosure, a RF chip includes a RF front-end and a digital front-end operatively coupled to the RF front-end. The digital front-end includes a set of registers storing a length of a cyclic suffix. The digital front-end also includes a WOLA module configured to copy a portion of a first symbol identified based on the length of the cyclic suffix, and append the copied portion to an end of the first symbol with a ramping-down window to form a weighed cyclic suffix of the first symbol.

In some embodiments, the digital front-end further includes a buffer configured to store the copied portion of the first symbol.

In some embodiments, to copy the portion of the first symbol, the WOLA module is configured to store the portion of the first symbol into the buffer as the first symbol streams through the digital front-end, and retrieve the copied portion of the first symbol from the buffer in response to the end of the first symbol reaching the digital front-end.

In some embodiments, a size of the buffer is not greater than 100 bytes.

In some embodiments, the digital front-end further includes a symbol boundary signal generator configured to periodically generate symbol boundary signals each indicative of a beginning of a respective cyclic prefix of each symbol. In some embodiments, the set of registers further store a length of the cyclic prefix.

In some embodiments, the weighed cyclic suffix of the first symbol overlaps the cyclic prefix of a second symbol next to the first symbol.

In some embodiments, the overlapped cyclic prefix is weighed by a ramping-up window.

In some embodiments, the WOLA module is further configured to identify a beginning of the copied portion of the first symbol based on a corresponding symbol boundary signal and the length of the cyclic prefix, and determine a length of the copied portion of the first symbol based on the length of the cyclic suffix.

In some embodiments, the digital front-end further includes a symbol counter configured to count a number of symbols in a slot.

In some embodiments, the length of the cyclic prefix includes a length of a normal cyclic prefix and a length of an extended cyclic prefix. In some embodiments, the WOLA module is further configured to apply the length of the normal cyclic prefix or the length of the extended cyclic prefix to identify the beginning of the copied portion of the first symbol based on the number of the symbols in the slot.

In some embodiments, the digital front-end further includes a gain control module configured to receive the first symbol from a baseband chip, and adjust a gain of the first symbol prior to copying the portion of the first symbol.

In some embodiments, the first symbol sequentially streams through the digital front-end and the RF front-end.

In some embodiments, the first symbol is an OFDM symbol.

According to another aspect of the present disclosure, an apparatus for wireless communication includes a baseband chip and a RF chip including a digital front-end. The baseband chip is configured to generate a stream of OFDM symbols. The digital front-end includes a gain control module configured to adjust gains of the stream of OFDM symbols received from the baseband chip, and a WOLA module configured to apply WOLA to the stream of OFDM symbols with adjusted gains in a streamlined manner

In some embodiments, the digital front-end further includes a symbol boundary signal generator configured to periodically generate symbol boundary signals each indicative of a beginning of a respective cyclic prefix of each OFDM symbol, and a set of registers storing a length of the cyclic prefix and a length of a cyclic suffix.

In some embodiments, to apply WOLA to the stream of OFDM symbols, the WOLA module is configured to copy a portion of each OFDM symbol identified based on the respective symbol boundary signal, the length of the cyclic prefix, and the length of the cyclic suffix, and append the copied portion to an end of the respective OFDM symbol with a ramping-down window to form a weighed cyclic suffix of the respective OFDM symbol.

In some embodiments, the WOLA module is further configured to identify a beginning of the copied portion of the respective OFDM symbol based on the respective symbol boundary signal and the length of the cyclic prefix, and determine a length of the copied portion of the respective OFDM symbol based on the length of the cyclic suffix.

In some embodiments, the digital front-end further includes a buffer configured to store the copied portion of the respective OFDM symbol.

In some embodiments, to copy the portion of each OFDM symbol, the WOLA module is configured to store the portion of the respective OFDM symbol into the buffer as the respective OFDM symbol streams through the digital front-end, and retrieve the copied portion of the respective OFDM symbol from the buffer in response to the end of the respective OFDM symbol reaching the digital front-end.

In some embodiments, a size of the buffer is not greater than 100 bytes.

In some embodiments, the weighed cyclic suffix of each OFDM symbol overlaps the cyclic prefix of another OFDM symbol next to the respective OFDM symbol.

In some embodiments, the overlapped cyclic prefix is weighed by a ramping-up window.

In some embodiments, the digital front-end further includes a symbol counter configured to count a number of OFDM symbols in a slot.

In some embodiments, the length of the cyclic prefix comprises a length of a normal cyclic prefix and a length of an extended cyclic prefix. In some embodiments, the WOLA module is further configured to apply the length of the normal cyclic prefix or the length of the extended cyclic prefix to identify the beginning of the copied portion of the respective OFDM symbol based on the number of the OFDM symbols in the slot.

In some embodiments, the stream of OFDM symbols generated by the baseband chip are free of WOLA and adjusted gains.

According to still another aspect of the present disclosure, a method implemented by a RF chip for wireless communication is disclosed. A length of a cyclic suffix is obtained. A portion of a first symbol identified based on the length of the cyclic suffix is copied. The copied portion is appended to an end of the first symbol with a ramping-down window to form a weighed cyclic suffix of the first symbol.

In some embodiments, to copy the portion of the first symbol, the portion of the first symbol is stored, and the copied portion of the first symbol is retrieved in response to reaching the end of the first symbol.

In some embodiments, symbol boundary signals each indicative of a beginning of a respective cyclic prefix of each symbol are periodically generated, and a length of the cyclic prefix is obtained.

In some embodiments, the weighed cyclic suffix of the first symbol overlaps the cyclic prefix of a second symbol next to the first symbol.

In some embodiments, the overlapped cyclic prefix is weighed by a ramping-up window.

In some embodiments, a beginning of the copied portion of the first symbol is identified based on a corresponding symbol boundary signal and the length of the cyclic prefix, and a length of the copied portion of the first symbol is determined based on the length of the cyclic suffix.

In some embodiments, a number of symbols in a slot is counted.

In some embodiments, the length of the cyclic prefix includes a length of a normal cyclic prefix and a length of an extended cyclic prefix. In some embodiments, the length of the normal cyclic prefix or the length of the extended cyclic prefix is applied to identify the beginning of the copied portion of the first symbol based on the number of the symbols in the slot.

In some embodiments, the first symbol is received from a baseband chip, and a gain of the first symbol is adjusted prior to copying the portion of the first symbol.

In some embodiments, the first symbol is an OFDM symbol.

According to yet another aspect of the disclosure, a method for wireless communication is disclosed. A stream of OFDM symbols are generated by a baseband chip. Gains of the stream of OFDM symbols received from the baseband chip are adjusted by a RF chip. WOLA is applied by the RF chip to the stream of OFDM symbols with adjusted gains in a streamlined manner

In some embodiments, symbol boundary signals each indicative of a beginning of a respective cyclic prefix of each OFDM symbol are periodically generated by the RF chip, and a length of the cyclic prefix and a length of a cyclic suffix are obtained by the RF chip.

In some embodiments, to apply WOLA to the stream of OFDM symbols, a portion of each OFDM symbol identified based on the respective symbol boundary signal, the length of the cyclic prefix, and the length of the cyclic suffix are copied, and the copied portion is appended to an end of the respective OFDM symbol with a ramping-down window to form a weighed cyclic suffix of the respective OFDM symbol.

In some embodiments, a beginning of the copied portion of the respective OFDM symbol is identified based on the respective symbol boundary signal and the length of the cyclic prefix, and a length of the copied portion of the respective OFDM symbol is determined based on the length of the cyclic suffix.

In some embodiments, to copy the portion of each OFDM symbol, the portion of the respective OFDM symbol is stored, and the copied portion of the respective OFDM symbol is retrieved in response to reaching the end of the respective OFDM symbol.

In some embodiments, the weighed cyclic suffix of each OFDM symbol overlaps the cyclic prefix of another OFDM symbol next to the respective OFDM symbol.

In some embodiments, the overlapped cyclic prefix is weighed by a ramping-up window.

In some embodiments, a number of OFDM symbols in a slot is counted by the RF chip.

In some embodiments, the length of the cyclic prefix includes a length of a normal cyclic prefix and a length of an extended cyclic prefix. In some embodiments, the length of the normal cyclic prefix or the length of the extended cyclic prefix is applied by the RF chip to identify the beginning of the copied portion of the respective OFDM symbol based on the number of the OFDM symbols in the slot.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A radio frequency (RF) chip, comprising:
a RF front-end; and
a digital front-end, operatively coupled to the RF front-end, and comprising:
a set of registers storing a length of a cyclic suffix; and
a weighted overlap-and-add (WOLA) module configured to:
copy a portion of a first symbol identified based on the length of the cyclic suffix; and
append the copied portion to an end of the first symbol with a ramping-down window to form a weighed cyclic suffix of the first symbol.

2. The RF chip of claim 1, wherein the digital front-end further comprises a buffer configured to store the copied portion of the first symbol.

3. The RF chip of claim 2, wherein, to copy the portion of the first symbol, the WOLA module is configured to:
store the portion of the first symbol into the buffer as the first symbol streams through the digital front-end; and
retrieve the copied portion of the first symbol from the buffer in response to the end of the first symbol reaching the digital front-end.

4. The RF chip of claim 2, wherein a size of the buffer is not greater than 100 bytes.

5. The RF chip of claim 1, wherein the digital front-end further comprises a symbol boundary signal generator configured to periodically generate symbol boundary signals each indicative of a beginning of a respective cyclic prefix of each symbol, wherein the set of registers further store a length of the cyclic prefix.

6. The RF chip of claim 5, wherein the weighed cyclic suffix of the first symbol overlaps the cyclic prefix of a second symbol next to the first symbol.

7. The RF chip of claim 6, wherein the overlapped cyclic prefix is weighed by a ramping-up window.

8. The RF chip of claim 5, wherein the WOLA module is further configured to:
identify a beginning of the copied portion of the first symbol based on a corresponding symbol boundary signal and the length of the cyclic prefix; and
determine a length of the copied portion of the first symbol based on the length of the cyclic suffix.

9. The RF chip of claim 8, wherein the digital front-end further comprises a symbol counter configured to count a number of symbols in a slot.

10. The RF chip of claim 9, wherein
the length of the cyclic prefix comprises a length of a normal cyclic prefix and a length of an extended cyclic prefix; and
the WOLA module is further configured to apply the length of the normal cyclic prefix or the length of the extended cyclic prefix to identify the beginning of the copied portion of the first symbol based on the number of the symbols in the slot.

11. The RF chip of claim 1, wherein the digital front-end further comprises a gain control module configured to:
receive the first symbol from a baseband chip; and
adjust a gain of the first symbol prior to copying the portion of the first symbol.

12. The RF chip of claim 1, wherein the first symbol sequentially streams through the digital front-end and the RF front-end.

13. The RF chip of claim 1, wherein the first symbol is an orthogonal frequency-division multiplexing (OFDM) symbol.

14. An apparatus for wireless communication, comprising:
a baseband chip configured to generate a stream of orthogonal frequency-division multiplexing (OFDM) symbols; and
a radio frequency (RF) chip comprising a digital front-end comprising:
a gain control module configured to adjust gains of the stream of OFDM symbols received from the baseband chip; and
a weighted overlap-and-add (WOLA) module configured to apply WOLA to the stream of OFDM symbols with adjusted gains in a streamlined manner.

15. The apparatus of claim 14, wherein the digital front-end further comprises:
a symbol boundary signal generator configured to periodically generate symbol boundary signals each indicative of a beginning of a respective cyclic prefix of each OFDM symbol; and
a set of registers storing a length of the cyclic prefix and a length of a cyclic suffix.

16. The apparatus of claim 15, wherein, to apply WOLA to the stream of OFDM symbols, the WOLA module is configured to:
copy a portion of each OFDM symbol identified based on the respective symbol boundary signal, the length of the cyclic prefix, and the length of the cyclic suffix; and
append the copied portion to an end of the respective OFDM symbol with a ramping-down window to form a weighed cyclic suffix of the respective OFDM symbol.

17. A method for wireless communication, comprising:
generating, by a baseband chip, a stream of orthogonal frequency-division multiplexing (OFDM) symbols;
adjusting, by a radio frequency (RF) chip, gains of the stream of OFDM symbols received from the baseband chip; and
applying, by the RF chip, weighted overlap-and-add (WOLA) to the stream of OFDM symbols with adjusted gains in a streamlined manner.

18. The method of claim 17, further comprising:
periodically generating, by the RF chip, symbol boundary signals each indicative of a beginning of a respective cyclic prefix of each OFDM symbol; and
obtaining, by the RF chip, a length of the cyclic prefix and a length of a cyclic suffix.

19. The method of claim 18, wherein applying WOLA to the stream of OFDM symbols comprises:
copying a portion of each OFDM symbol identified based on the respective symbol boundary signal, the length of the cyclic prefix, and the length of the cyclic suffix; and
appending the copied portion to an end of the respective OFDM symbol with a ramping-down window to form a weighed cyclic suffix of the respective OFDM symbol.

20. The method of claim 19, further comprising:
identifying, by the RF chip, a beginning of the copied portion of the respective OFDM symbol based on the respective symbol boundary signal and the length of the cyclic prefix; and
determining, by the RF chip, a length of the copied portion of the respective OFDM symbol based on the length of the cyclic suffix.
